(19) United States
(12) Patent Application Publication
(10) Pub. No.: US 2024/0127487 A1
(43) Pub. Date: Apr. 18, 2024

(54) METHOD AND DEVICE OF ENCODING/DECODING AN IMAGE BASED ON MULTI-COMPRESSION LEVEL

(71) Applicants: Electronics and Telecommunications Research Institute, Daejeon (KR); Konkuk University Industrial Cooperation Corp, Seoul (KR)

(72) Inventors: Han Shin LIM, Daejeon (KR); Sang Woon KWAK, Daejeon (KR); Hyon Gon CHOO, Daejeon (KR); Kyoung Ro YOON, Seoul (KR); Shin KIM, Seoul (KR); Ye Gi LEE, Seoul (KR)

(73) Assignees: Electronics and Telecommunications Research Institute, Daejeon (KR); Konkuk University Industrial Cooperation Corp, Seoul (KR)

(21) Appl. No.: 18/484,566

(22) Filed: Oct. 11, 2023

(30) Foreign Application Priority Data
Oct. 12, 2022 (KR) 10-2022-0130946
Sep. 20, 2023 (KR) 10-2023-0125930

(51) Int. Cl. G06T 9/00; G06V 10/25

(52) U.S. Cl. CPC G06T 9/00; G06V 10/25

(57) ABSTRACT

An image encoding/decoding method, device and recording medium based sed on multiple compression levels disclosure may include extracting a region of interest for machine vision from an input image, determining a compression level of the region of interest, and encoding the compression level of the region of interest.

### CROSS-REFERENCE TO RELATED APPLICATIONS

This application claims the benefit of earlier filing date and right of priority to Korean Application NO. 10-2022-0130946, filed on Oct. 12, 2022, and right of priority to Korean Application NO. 10-2023-0125930, filed on Sep. 20, 2023, the contents of which are all hereby incorporated by reference herein in their entirety.

### TECHNICAL FIELD

The present disclosure relates to an image encoding/decoding method and device.

### BACKGROUND ART

A success of technology in a field of machine vision, such as image recognition and image division using an image as an input, is converging with existing industrial fields and expanding its scope of application to new fields such as smart cities, autonomous driving, smart factories, and smart contents. Through this, the use of images for use in machines (machine vision) is increasing. In this case, setting a goal of video compression to increase the compression rate while maintaining accuracy as much as possible when applying machine learning tasks may be a way to further increase the usefulness of video compression technology. Therefore, considering the characteristics of machine vision, there is an urgent need for image processing technology that increases the compression rate while maintaining machine vision performance.

### DISCLOSURE

### Technical Problem

The purpose of the disclosure is to provide images with a high compression rate while maintaining machine vision task performance in consideration of characteristics of machine vision tasks.

### Technical Solution

An image encoding/decoding method, device and recording medium based on multiple compression levels may include extracting a region of interest for machine vision from an input image, determining a compression level of the region of interest, and encoding the compression level of the region of interest.

In an image encoding/decoding method, device and recording medium based on multiple compression levels of the present disclosure, the compression level of the region of interest may be determined using a compression rate control algorithm, and an input of the compression rate control algorithm may be information about the region of interest.

In an image encoding/decoding method, device and recording medium based on multiple compression levels of the present disclosure, the information about the region of interest may include at least one of a size of the region of interest, a pixel value belonging to the region of interest, an object type belonging to the region of interest, or a proximity to a neighboring region of interest.

In an image encoding/decoding method, device and recording medium based on multiple compression levels of the present disclosure, the compression level of the region of interest may be determined based on a probability distribution model between the information about the region of interest and a compression rate control parameter.

In an image encoding/decoding method, device and recording medium based on multiple compression levels of the present disclosure, the compression rate control parameter may include at least one of a resolution level or a quantization level.

In an image encoding/decoding method, device and recording medium based on multiple compression levels of the present disclosure, the compression level may be defined by a resolution level or a quantization level.

In an image encoding/decoding method, device and recording medium based on multiple compression levels of the present disclosure, the compression level may be defined as a combination of a resolution level and a quantization level.

In an image encoding/decoding method, device and recording medium based on multiple compression levels of the present disclosure, in response of the resolution level having higher priority and the quantization level having lower priority, a region of interest detection process may be performed on compression level candidates to which resolution level candidates belong in an order of quantization level candidates.

In an image encoding/decoding method, device and recording medium based on multiple compression levels of the present disclosure, the order of the quantization level candidates may be from a maximum quantization level candidate to a minimum quantization level candidate.

In an image encoding/decoding method, device and recording medium based on multiple compression levels of the present disclosure, the order of the quantization level candidates may be from a minimum quantization level candidate to a maximum value quantization level candidate.

### Technical Effects

According to the present disclosure, an image with a high compression rate may be generated while maintaining machine vision task performance by considering characteristics of machine vision tasks.

### DESCRIPTION OF DRAWINGS

FIG. 1 illustrates an image encoding device 100 based on multiple compression levels according to the present disclosure.

FIG. 2 illustrates an image encoding method based on multiple compression levels according to the present disclosure.

FIG. 3 illustrates an image encoding method based on a probability distribution model according to the present disclosure.

FIG. 4 illustrates an image decoding device 400 according to the present disclosure.

FIG. 5 illustrates an image decoding method in an image decoding device according to the present disclosure.

### BEST MODE

As the present disclosure may make various changes and have several embodiments, specific embodiments will be illustrated in a drawing and described in detail. But, it is not intended to limit the present disclosure to a specific embodiment, and it should be understood that it includes all changes, equivalents or substitutes included in an idea and a technical scope for the present disclosure. A similar reference sign is used for a similar component while describing each drawing.

A term such as first, second, etc. may be used to describe various components, but the components should not be limited by the terms. The terms are used only to distinguish one component from other components. For example, without going beyond a scope of a right of the present disclosure, a first component may be referred to as a second component and similarly, a second component may be also referred to as a first component. A term, and/or, includes a combination of a plurality of relative entered items or any item of a plurality of relative entered items.

When a component is referred to as being “linked” or “connected” to other component, it should be understood that it may be directly linked or connected to other component, but other component may exist in the middle. On the other hand, when a component is referred to as being “directly linked” or “directly connected” to other component, it should be understood that other component does not exist in the middle.

As a term used in this application is only used to describe a specific embodiment, it is not intended to limit the present disclosure. Expression of the singular includes expression of the plural unless it clearly has a different meaning contextually. In this application, it should be understood that a term such as “include” or “have”, etc. is to designate the existence of features, numbers, steps, motions, components, parts or their combinations entered in a specification, but is not to exclude the existence or possibility of addition of one or more other features, numbers, steps, motions, components, parts or their combinations in advance.

The present disclosure provides a compression rate control method that increases image encoding performance while maintaining machine vision (e.g., object detection, image division, object tracking, object extraction, etc.) performance. In particular, by encoding an image by adjusting a compression level based on a region (hereinafter, referred to as a region of interest) within the image that affects the performance of machine vision, the compression rate may be increased while maintaining the performance of machine vision.

According to the present disclosure, one image may include one or more regions of interest. By adjusting at least one of the resolution level or quantization level for each region of interest, the optimal compression level for the region of interest may be determined. Accordingly, a compression level for one of a plurality of regions of interest may be different from a compression level for another one. Here, different compression levels may mean that at least one of a resolution level or a quantization level is different.

Additionally, considering properties of a region of interest extracted from an input image, an optimal compression level for each region of interest may be determined. Considering properties of the region of interest, a number or a range of levels for at least one of the resolution level or the quantization level described above may be set differently. Considering the properties of the region of interest, it may be limited to selectively adjust either the resolution level or the quantization level.

In the present disclosure, properties of a region of interest include a size of the region of interest (e.g., width, height, product of width and height, ration of width and height, etc.), pixel values belonging to the region of interest (e.g., minimum value, maximum value, difference between maximum value and minimum value, amount of pixel value change, etc.), object type belonging to the region of interest, adjacency to a neighboring region of interest (e.g., presence of absence of the neighboring region of interest adjacent to a current region of interest, distance from the neighboring region of interest, etc.), a number/position of regions of interest in one image, or object detection rate. The properties of the region of interest described above may be applied in the same sense to embodiments described later. Hereinafter, we will take a closer look at an image encoding/decoding method based on multiple compression levels with reference to the drawings.

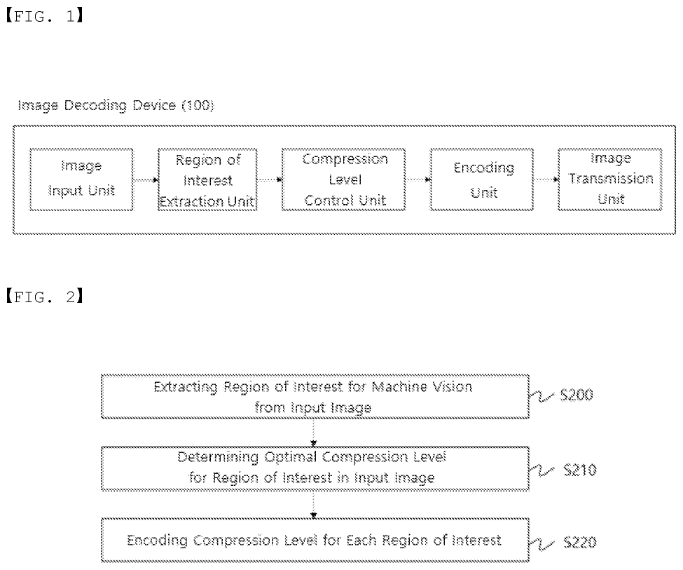

FIG. 1 illustrates an image encoding device 100 based on multiple compression levels according to the present disclosure.

Referring to FIG. 1, an image encoding device 100 may include at least one of an image input unit, a region of interest extraction unit, a compression level control unit, an encoding unit, or an image transmission unit.

An image input unit may receive an image. In the present disclosure, an image input to an image input unit may mean an image itself captured by a camera, or may mean an image encoded/decoded by a predetermined video codec.

A region of interest extraction unit may extract a region of interest for machine vision from an image received through an image input unit. Here, machine vision may be understood as a concept distinct from human vision.

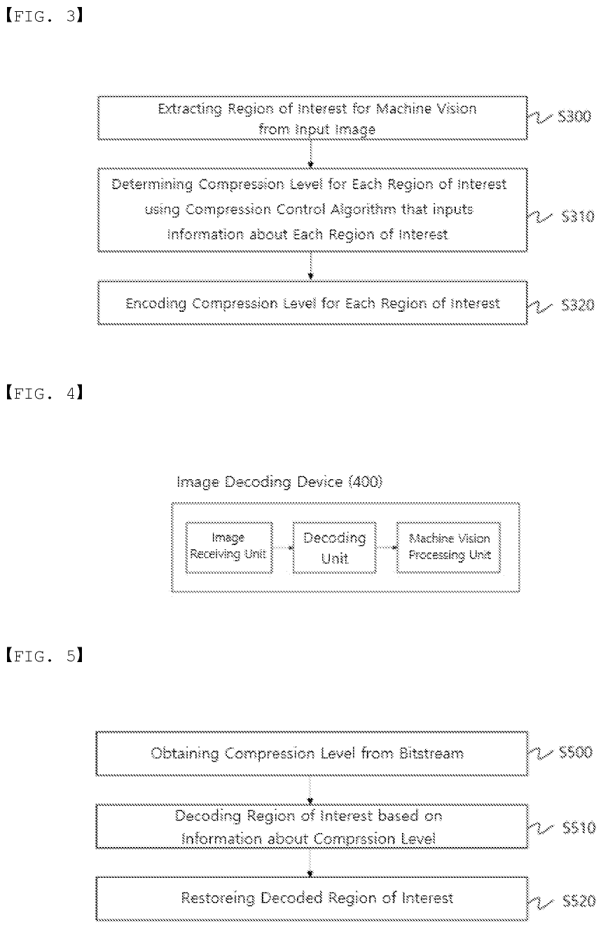

A compression level control unit may determine an optimal compression level by adjusting at least one of a compression level, that is, a resolution level or a quantization level, for each of one or more regions of interest extracted through a region of interest extraction unit. Let's take a closer look at how to determine a compression level of a region of interest with reference to FIGS. 2 and 3.

An encoding unit may generate a bitstream by encoding a compression level for each region of interest determined by an compression level control unit. An encoding unit may encode information about properties of a region of interest extracted from a region of interest extraction unit, and this may be included in a bitstream.

An image transmission unit may transmit a bitstream generated in an encoding unit to an image decoding device. Accordingly, an image transmission unit may store program instructions for transmitting a bitstream generated in an encoding unit.

FIG. 2 illustrates an image encoding method based on multiple compression levels according to the present disclosure.

Referring to FIG. 2, a region of interest extraction unit of an image encoding device 100 may extract a region of interest for machine vision from an input image (S200). Here, the region of interest is a region within the image that affects machine vision performance and may mean a region containing a machine vision-related object. Alternatively, the region of interest may be a region obtained through image division for a specific task or machine vision. The region may have a polygonal shape or a square shape. Alternatively, the region may be a set of discontinuous regions. For example, when a first region and a second region are not continuous, the region of interest may be a region including the first region and the second region. One or more regions of interest may be extracted from an input image, and at least one of a plurality of regions of interest may have a different size/shape than another region of interest. Additionally, one extracted region of interest may overlap with another region of interest.

Referring to FIG. 2, a compression level control unit of an image encoding device 100 may determine an optimal compression level for a region of interest in an input image (S210). In the present disclosure, a compression level may include at least one of a resolution level or a quantization level. That is, a compression level may be defined only as a resolution level or a quantization level, or a compression level may be defined as a combination of a resolution level and a quantization level. For convenience of explanation, it is assumed that the compression level according to the present disclosure is defined as a combination of a resolution level and a quantization level.

First, an image encoding device 100 includes N resolution level candidates (R₁, R₂, . . . , R_{N-1}, R_{N}) and M quantization level candidates (Q₁, Q₂, . . . , Q_{M-1}, Q_{M}) may be defined respectively.

In a first embodiment, the resolution level candidate R₁ may correspond to a minimum value among pre-defined resolution level candidates, and a resolution level candidate R_{N} may correspond to a maximum value among the pre-defined resolution level candidates. On the other hand, a quantization level candidate Q₁ may correspond to a maximum value among pre-defined quantization level candidates, and a quantization level candidate Q_{M} may correspond to a minimum value among pre-defined resolution level candidates.

In a second embodiment, a resolution level candidate R₁ may correspond to a maximum value among the pre-defined resolution level candidates, and a resolution level candidate R_{N} may correspond to a minimum value among the pre-defined resolution level candidates. On the other hand, a quantization level candidate Q₁ may correspond to a minimum value among pre-defined quantization level candidates, and a quantization level candidate Q_{M} may correspond to a maximum value among pre-defined resolution level candidates.

In a third embodiment, a resolution level candidate R₁ may correspond to a maximum value among the pre-defined resolution level candidates, and a resolution level candidate R_{N} may correspond to a minimum value among the pre-defined resolution level candidates. Additionally, a quantization level candidate Q₁ may correspond to a maximum value among pre-defined quantization level candidates, and a quantization level candidate Q_{M} may correspond to a minimum value among pre-defined resolution level candidates.

In a fourth embodiment, a resolution level candidate R₁ may correspond to a minimum value among pre-defined resolution level candidates, and a resolution level candidate R_{N} may correspond to a maximum value among the pre-defined resolution level candidates. In addition, a quantization level candidate Q₁ may correspond to a minimum value among pre-defined quantization level candidates, and a quantization level candidate Q_{M} may correspond to a maximum value among pre-defined resolution level candidates.

N and M may be pre-defined values in an image encoding device. Additionally, a region of interest may be set differently for each region of interest based on at least one of the properties of the region of interest described above. An i-th resolution level candidate and an (i+1)-th resolution level candidate may have a predetermined difference or gap (Dᵢ) (1≤i≤(N−1)). The difference Dᵢ may be the same regardless of the value of i, or may be different depending on the value of i. Likewise, an j-th quantization level candidate and an (j+1-)th quantization level candidate may have a predetermined difference or gap (Dⱼ) (1≤j≤(M−1)). The difference Dⱼ may be the same regardless of the value of j, or may be different depending on the value of j.

For example, resolution level candidates may range from 25 to 100, and a difference (Dᵢ) between resolution level candidates may be 25. Quantization level candidates may range from 22 to 47, and a difference (Dⱼ) between quantization level candidates may be 5. That is, in an image encoding device 100, four resolution level candidates, i.e., (25, 50, 75, 100) and six quantization level candidates, i.e., (47, 42, 37, 32, 27, 22) may be defined, respectively.

In an image encoding device 100, a total of (N*M) compression level candidates may be defined through a combination of the above-described resolution level candidates and quantization level candidates. An optimal compression level for a region of interest may be determined from compression level candidates pre-defined in an image encoding device.

Specifically, based on each pre-defined compression level candidate, an input image may be encoded, and the encoded input image may be decoded again. Then, it may be checked whether a region of interest is detected in the decoded image. In this case, encoding/decoding of an input video may be performed sequentially according to a predetermined priority among pre-defined compression level candidates, and the encoding/decoding process of the input image may be performed only until a region of interest is detected in the decoded image. In other words, it is checked whether a region of interest in an image is detected for each pre-defined compression level candidate according to a predetermined priority, and when a region of interest is detected for a specific compression level candidate, an encoding/decoding process of an input image based on remaining compression level candidates with priority after the specific compression level candidate may not be performed any further and may be terminated early. Therefore, an optimal compression level according to the present disclosure may mean a compression level candidate with the highest compression rate among compression level candidates that enable detection of a region of interest from an image. Hereinafter, with reference to the embodiment, we will take a closer look at a method of determining an optimal compression level for a region of interest.

One of a resolution level and a quantization level included in a compression level may be classified as having a higher priority, and the other may be classified as having a lower priority. Hereinafter, a compression level with higher priority may be referred to as a main compression level, and a compression level with lower priority may be referred to as a sub compression level.

### Embodiment 1-A

This embodiment relates to a case where a resolution level is a main compression level and a quantization level is a sub compression level.

According to this embodiment, it is possible to check whether a region of interest in an image is detected for a compression level candidate to which a resolution level candidate (Rᵢ), which is a main compression level, belongs (hereinafter, referred to as a region of interest detection process). In this case, there may be multiple compression level candidates to which Rᵢ belongs, and a region of interest detection process may be performed simultaneously on these candidates, or a region of interest detection process may be performed sequentially based on a predetermined priority. The priority may mean an order of a compression level candidates including a maximum quantization level candidate (Q₁) to a compression level candidate including a minimum quantization level candidate (Q_{M}). Then, a region of interest detection process may be performed on a compression level candidate to which a resolution level candidate (R₍ᵢ₊₁₎) belongs. Likewise, there may be multiple compression level candidates to which R₍ᵢ₊₁₎ belongs, and a region of interest detection process may be performed on them simultaneously, or a region of interest detection process may be performed sequentially based on the above-mentioned priorities.

According to the above-described method, a region of interest detection process may be performed sequentially from a compression level candidate to which R₁ belongs to a compression level candidate to which R_{N} belongs. Alternatively, a region of interest detection process may be performed sequentially from a default compression level candidate pre-defined in an image encoding device to a compression level candidate to which R_{N} belongs. The default compression level candidate is one of pre-defined compression level candidates and may be an initial value of the compression level candidate for starting a region of interest detection process. However, a region of interest detection process may be terminated early as soon as a compression level candidate at which a region of interest in an image is detected is found. A compression level candidate at which a region of interest is detected may be determined as an optimal compression level for a region of interest. However, even though a region of interest detection process was performed sequentially from a default compression level candidate to a compression level candidate to which R_{N} belongs, if a compression level candidate at which a region of interest in an image is detected is not found, an optimal compression level for the region of interest may be set as the default compression level candidate.

### Embodiment 1-B

Inversely, according to this embodiment, it is possible to check whether a region of interest in an image is detected for a compression level candidate to which a resolution level candidate (Rᵢ), which is a main compression level, belongs (hereinafter, referred to as a region of interest detection process). In this case, there may be multiple compression level candidates to which Rᵢ belongs, and a region of interest detection process may be performed simultaneously on these candidates, or a region of interest detection process may be performed sequentially based on a predetermined priority. The priority may mean an order of a compression level candidate including a minimum quantization level candidate (Q_{M}) to a compression level candidates including a maximum quantization level candidate (Q₁). Then, a region of interest detection process may be performed on a compression level candidate to which a resolution level candidate (R₍ᵢ₋₁₎) belongs. Likewise, there may be multiple compression level candidates to which R₍ᵢ₋₁₎ belongs, and a region of interest detection process may be performed on them simultaneously, or a region of interest detection process may be performed sequentially based on the above-mentioned priorities.

According to the above-described method, a region of interest detection process may be performed sequentially from a compression level candidate to which R_{N} belongs to a compression level candidate to which R₁ belongs. Alternatively, a region of interest detection process may be performed sequentially from a default compression level candidate pre-defined in an image encoding device to a compression level candidate to which R₁ belongs. The default compression level candidate is one of pre-defined compression level candidates and may be an initial value of the compression level candidate for starting a region of interest detection process. However, a region of interest detection process may be terminated early as soon as a compression level candidate at which a region of interest in an image is not detected is found. A compression level candidate used immediately before a compression level candidate for which a region of interest is not detected may be determined as an optimal compression level for a region of interest. However, even though a region of interest detection process was performed sequentially from a default compression level candidate to a compression level candidate to which R₁ belongs, if a compression level candidate at which a region of interest in an image is not detected is not found, an optimal compression level for the region of interest may be set as the default compression level candidate.

### Embodiment 2-A

This embodiment relates to a case where a resolution level is a sub compression level and a quantization level is a main compression level.

According to this embodiment, it is possible to check whether a region of interest in an image is detected for a compression level candidate to which a quantization level candidate (Qⱼ), which is a main compression level, belongs (hereinafter, referred to as a region of interest detection process). In this case, there may be multiple compression level candidates to which Qⱼ belongs, and a region of interest detection process may be performed simultaneously on these candidates, or a region of interest detection process may be performed sequentially based on a predetermined priority. The priority may mean an order of a compression level candidates including a minimum resolution level candidate (R₁) to a compression level candidate including a maximum resolution level candidate (R_{N}). Then, a region of interest detection process may be performed on a compression level candidate to which a quantization level candidate (Q₍ⱼ₊₁₎) belongs. Likewise, there may be multiple compression level candidates to which Q₍ⱼ₊₁₎ belongs, and a region of interest detection process may be performed on them simultaneously, or a region of interest detection process may be performed sequentially based on the above-mentioned priorities.

According to the above-described method, a region of interest detection process may be performed sequentially from a compression level candidate to which Q₁ belongs to a compression level candidate to which Q_{M} belongs. Alternatively, a region of interest detection process may be performed sequentially from a default compression level candidate pre-defined in an image encoding device to a compression level candidate to which Q_{M} belongs. The default compression level candidate is one of pre-defined compression level candidates and may be an initial value of the compression level candidate for starting a region of interest detection process. However, a region of interest detection process may be terminated early as soon as a compression level candidate at which a region of interest in an image is detected is found. A compression level candidate at which a region of interest is detected may be determined as an optimal compression level for a region of interest. However, even though a region of interest detection process was performed sequentially from a default compression level candidate to a compression level candidate to which Q_{M} belongs, if a compression level candidate at which a region of interest in an image is detected is not found, an optimal compression level for the region of interest may be set as the default compression level candidate.

### Embodiment 2-B

Inversely, according to this embodiment, it is possible to check whether a region of interest in an image is detected for a compression level candidate to which a quantization level candidate (q), which is a main compression level, belongs (hereinafter, referred to as a region of interest detection process). In this case, there may be multiple compression level candidates to which Qⱼ belongs, and a region of interest detection process may be performed simultaneously on these candidates, or a region of interest detection process may be performed sequentially based on a predetermined priority. The priority may mean an order of a compression level candidate including a maximum resolution level candidate (R_{N}) to a compression level candidates including a minimum resolution level candidate (R₁). Then, a region of interest detection process may be performed on a compression level candidate to which a quantization level candidate (Q₍ⱼ₋₁₎) belongs. Likewise, there may be multiple compression level candidates to which Q₍ⱼ₋₁₎ belongs, and a region of interest detection process may be performed on them simultaneously, or a region of interest detection process may be performed sequentially based on the above-mentioned priorities.

According to the above-described method, a region of interest detection process may be performed sequentially from a compression level candidate to which Q_{M} belongs to a compression level candidate to which Q₁ belongs. Alternatively, a region of interest detection process may be performed sequentially from a default compression level candidate pre-defined in an image encoding device to a compression level candidate to which Q₁ belongs. The default compression level candidate is one of pre-defined compression level candidates and may be an initial value of the compression level candidate for starting a region of interest detection process. However, a region of interest detection process may be terminated early as soon as a compression level candidate at which a region of interest in an image is not detected is found. A compression level candidate used immediately before a compression level candidate for which a region of interest is not detected may be determined as an optimal compression level for a region of interest. However, even though a region of interest detection process was performed sequentially from a default compression level candidate to a compression level candidate to which Q₁ belongs, if a compression level candidate at which a region of interest in an image is not detected is not found, an optimal compression level for the region of interest may be set as the default compression level candidate.

The Embodiment 1-A and the Embodiment 2-A perform a region of interest detection process in an order of a compression level candidate with a high compression ratio to a compression level candidate with a low compression ratio, and the Embodiment 1-B and the Embodiment 2-B perform a region of interest detection process in an order of a compression level candidate with a low compression ratio to a compression level candidate with a high compression ratio. Only one of the four embodiments may be implemented in an image encoding device, or at least two embodiments of the four embodiments may be implemented in an image encoding device, and any one of them may be selectively used. Here, the selection may be performed based on at least one of properties of the region of interest described above. Based on the selection, information about the properties of the region of interest that determines the selection may be encoded by an encoding unit, or index information representing only some of a plurality of embodiments may be encoded by an encoding unit.

### Embodiment 3

A compression level control unit may set a compression level candidate selected in the embodiment 1-A (or the embodiment 1-B) as a first temporary compression level and a compression level candidate selected in the embodiment 2-A (or the embodiment 2-B) as a second temporary compression level, respectively. A compression level control unit may compare a compression rate corresponding to the first temporary compression level with a compression rate corresponding to the second temporary compression level. As a result of the comparison, a temporary compression level with the higher compression ratio may be determined as an optimal compression level for the corresponding region of interest. Additionally, based on the determination, index information indicating either the first temporary compression level or the second temporary compression level may be encoded by an encoding unit.

Referring to FIG. 2, an encoding unit of an image encoding device 100 may encode a compression level for each region of interest determined by a compression level control unit (S220). In addition, index information used to determine a compression level may be encoded. In addition, an encoding unit may encode information about properties of the region of interest in an image.

FIG. 3 illustrates an image encoding method based on a probability distribution model according to the present disclosure.

The disclosure in FIG. 2 may be equally/similarly applied to an image encoding method based on a probability distribution model, and redundant description will be omitted.

Referring to FIG. 3, a region of interest extraction unit of an image encoding device 100 may extract a region of interest for machine vision from an input image (S300). A region of interest extraction unit may generate information about a region of interest based on the extracted region of interest. Here, information about a region of interest includes at least one of a size of a region of interest (e.g., width, height, product of width and height, ratio of width to height, etc.), a pixel value belonging to a region of interest (e.g., minimum value, maximum value, difference between maximum and minimum values, amount of change in pixel value, etc.), an object type belonging to a region of interest, a proximity to neighboring regions of interest (e.g., presence or absence of neighboring regions of interest adjacent to a current region of interest, distance to neighboring regions of interest, etc.), or a number/position of a region of interest belonging to one image.

Referring to FIG. 3, a compression level control unit of an image encoding device 100 may determine a compression level for each region of interest using a compression rate control algorithm that inputs information about each region of interest (S310).

Specifically, a probability distribution model may be created between information on properties of a region of interest and a compression rate control parameter. Here, a compression rate control parameter may include at least one of a resolution level or a quantization level. A probability distribution model is expressed as P(x|θ), where x represents a observed data and θ represents a parameter. The probability distribution model according to the present disclosure may be defined as in Equation 1 or 2 below.

P (compression rate control parameter|information about properties of region of interest) [Equation 1]

P (information about properties of region of interest|compression rate control parameter) [Equation 2]

Here, P(A|B) may represent a conditional probability that A will occur given B.

A probability distribution model may be created based on learning data in which a relationship between information on properties of a region of interest and a compression rate control parameter is known in advance.

Alternatively, information on properties of a region of interest and a probability distribution model may be generated based on learning data that knows in advance a relationship between an image of a region of interest and a compression rate control parameter.

From the generated probability distribution model, an optimal compression rate control parameter may be obtained according to image information or information about properties of a region of interest.

For example, using learning data, a probability distribution model may be created for each compression rate control parameter, a probability corresponding to information about properties of a region of interest may be obtained for each compression rate control parameter, and an optimal compression level may be determined based on the compression rate control parameter when the probability is maximum.

Alternatively, a probability distribution model P (compression rate control parameter) for each compression rate control parameter may be estimated or determined in advance. Then, a probability distribution model as shown in Equation 3 may be generated for each compression rate control parameter, the compression rate control parameter may be selected when the probability is maximized in the probability distribution model based on information about the image information or properties of a given region of interest, and based on this, the optimal compression level for the region of interest may be determined.

P (compression rate control parameter|information about properties of region of interest)=P (information about properties of region of interest|compression rate control parameter)*P (compression rate control parameter) [Equation 3]

Referring to FIG. 3, an encoding unit of an image encoding device 100 may encode a compression level for each region of interest determined by a compression level control unit (S320). Additionally, an encoding unit may encode information about a region of interest generated by a region of interest extraction unit.

FIG. 4 illustrates an image decoding device 400 according to the present disclosure.

Referring to FIG. 4, an image decoding device 400 may include at least one of an image receiving unit, a decoding unit, or a machine vision processing unit.

An image receiving unit may receive a bitstream including an encoded image from an image encoding device.

A decoding unit may restore an image by decoding the bitstream received by an image receiving unit. Specifically, based on information about a compression level obtained from a a, a compression level for a region of interest, that is, the resolution level and a quantization level, may be determined. A region of interest may be decoded according to the determined compression level, and an image including the decoded region of interest may be restored. In this case, the decoded region of interest may be controlled to correspond to a position/size in an original image, and for this purpose, information (In particular, a position/size of a region of interest) about properties of the region of interest obtained a the bitstream may be used.

A machine vision processing unit may perform specific tasks such as object detection, image division, object tracking, and object extraction on a restored image.

FIG. 5 illustrates an image decoding method in an image decoding device according to the present disclosure.

Referring to FIG. 5, information about a compression level may be obtained from a bitstream (S500). An encoded image may include one or more regions of interest, and information about the compression level may be obtained for each region of interest included in an image. Information about a compression level may include at least one of information about a resolution level or information about a quantization level.

Referring to FIG. 5, decoding of a region of interest may be performed based on information about the obtained compression level (S510).

A compression level used for a region of interest may be determined based on information about an obtained compression level. In contrast, like a compression level control unit of an image encoding device 100, an optimal compression level for a region of interest may be determined. The details of determining a compression level have been described above and will be omitted below.

Based on information about a compression level, a compression level, that is, at least one of a resolution level or a quantization level, for a region of interest may be determined. A region of interest may be decoded according to the determined compression level (S510).

Referring to FIG. 5, an image including the decoded region of interest may be restored (S520).

A region of interest in a restored image may have a different location and/or size than a region of interest in an original image. Alternatively, a position/size of a decoded region of interest may be additionally controlled to correspond to a position/size of a region of interest in an original image, and for this purpose, information about properties of a region of interest (in particular, a location/size of a region of interest) obtained from a bitstream may be used.

When embodiments described based on a decoding process or an encoding process are applied to an encoding process or a decoding process, it is included in a scope of the present disclosure. When embodiments described in predetermined order are changed in order different from a description, it is also included in a scope of the present disclosure.

The above-described disclosure is described based on a series of steps or flow charts, but it does not limit time series order of the present disclosure and if necessary, it may be performed at the same time or in different order. In addition, each component (e.g., a unit, a module, etc.) configuring a block diagram in the above-described disclosure may be implemented as a hardware device or software and a plurality of components may be combined and implemented as one hardware device or software. The above-described disclosure may be recorded in a computer readable recoding medium by being implemented in a form of a program instruction which may be performed by a variety of computer components. The computer readable recoding medium may include a program instruction, a data file, a data structure, etc. solely or in combination. An example of a computer readable recoding medium includes magnetic media such as a hard disk, a floppy disk and a magnetic tape, optical recording media such as a CD-ROM and a DVD, magneto-optical media such as a floptical disk and a hardware device which is specially configured to store and execute a program instruction such as ROM, RAM, a flash memory, etc. The hardware device may be configured to operate as at least one software module in order to perform processing according to the present disclosure and vice versa. A device according to the present disclosure may have a program instruction for storing or transmitting a bitstream generated by the above-described encoding method.

What is claimed is:

1. An image encoding method based on multiple compression levels, the image encoding method comprising:
extracting a region of interest for machine vision from an input image;
determining a compression level of the region of interest; and
encoding the compression level of the region of interest.

2. The method of claim 1,
wherein the compression level of the region of interest is determined using a compression rate control algorithm, and
wherein an input of the compression rate control algorithm is information about the region of interest.

3. The method of claim 2,
wherein the information about the region of interest includes at least one of a size of the region of interest, a pixel value belonging to the region of interest, an object type belonging to the region of interest, or a proximity to a neighboring region of interest.

4. The method of claim 2,
wherein the compression level of the region of interest is determined based on a probability distribution model between the information about the region of interest and a compression rate control parameter.

5. The method of claim 4,
wherein the compression rate control parameter includes at least one of a resolution level or a quantization level.

6. The method of claim 1,
wherein the compression level is defined by a resolution level or a quantization level.

7. The method of claim 1,
wherein the compression level is defined as a combination of a resolution level and a quantization level.

8. The method of claim 7,
wherein, in response of the resolution level having higher priority and the quantization level having lower priority, a region of interest detection process is performed on compression level candidates to which resolution level candidates belong in an order of quantization level candidates.

9. The method of claim 8,
wherein the order of the quantization level candidates is from a maximum quantization level candidate to a minimum quantization level candidate.

10. The method of claim 8,
wherein the order of the quantization level candidates is from a minimum quantization level candidate to a maximum value quantization level candidate.

11. An image decoding method based on multiple compression levels, the image decoding method comprising:
obtaining information about a compression level of a region of interest from a bitstream;
decoding the region of interest based on the information about the compression level; and
restoring an image including the decoded region of interest.

12. A computer readable recording medium storing a bitstream generated by an image encoding method based on multiple compression levels, wherein the image encoding method includes:
extracting a region of interest for machine vision from an input image;
determining a compression level of the region of interest; and
encoding the compression level of the region of interest.
